(19) United States
(12) Patent Application Publication
(10) Pub. No.: US 2006/0077846 A1
(43) Pub. Date: Apr. 13, 2006

(54) Method of erasing power calibration area for deciding optimum power

(75) Inventors: Jin-woo Yu, Suwon-si (KR); Byung-hyun Min, Seoul (KR); Chi-ho Lee, Yongin-si (KR); Kang-uk Cho, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/180,525

(22) Filed: Jul. 14, 2005

(30) Foreign Application Priority Data
Oct. 8, 2004 (KR) 10-2004-0080186

(51) Int. Cl. G11B 7/00

(52) U.S. Cl. 369/53.24; 369/47.13; 369/47.52

(57) ABSTRACT

A method of erasing a power calibration area (PCA) for determining optimum power, including applying a command for recording data, detecting a non-recorded PCA area for performing optimum power control (OPC), and when all the PCA area is used and no non-recorded PCA area is detected, performing erasing of the PCA area at least twice. Accordingly, since the PCA area is erased at least twice, reliability of the optimum recording power determined by performing the OPC is much improved.

### CROSS REFERENCE TO RELATED APPLICATION

This application claims the benefit of Korean Patent Application No. 2004-80186, filed Oct. 8, 2004, in the Korean Intellectual Property Office, the disclosure of which is incorporated herein by reference.

### BACKGROUND OF THE INVENTION

1. Field of the Invention

The present invention relates to a method for erasing a power calibration area (PCA). More particularly, the present invention relates to a method for perfectly erasing a PCA by performing the erasing process at least twice to improve reliability of optimum power determined through optimum power control (OPC).

2. Description of the Related Art

Generally, optical recording media are divided, according to capability of repetitive recording, into a read-only memory (ROM), a write-once-read memory (WORM) capable of only one time of recording, and a rewritable (RW) capable of repetitive recording.

The ROM optical recording medium includes a compact disc (CD)-ROM and a digital versatile disc (DVD)-ROM. The WORM optical medium includes a CD-recordable (CD-R) and a DVD-R which are both one-time recordable medium.

The RW medium which can rewrite data many times includes a CD-RW and a DVD-RW.

Recording areas of the DVD-RW, for example, include a power calibration area (PCA) area, a programmable memory area (PMA) area, a lead-in area, a program area, and a lead-out area.

The PCA area corrects laser recording power for recording data of a disc. The PMA has leading address information of a track recorded with data, among the program areas. The lead-in area and the lead-out area records data recording information stored to the program area, and the program area records data for actual recording to the disc.

In order to obtain high-quality optical recording, optimum power control (OPC) process is indispensable. The OPC process is for determining an optimum recording power according to the recording medium and the discs having respectively different optical characteristics. In general, the OPC process is performed in a PCA allocated beforehand in the disc according to the Orange Book, which is the Trusted Computer Security Evaluation Criteria.

If the PCA area, where the OPC is performed, is filled up with data, the data should be erased for reuse. Usually, an operation of erasing the PCA area is performed once. However, the PCA area may not be completely cleared due to a disc defect such as a scratch, or instability of a tracking servo and a focusing servo.

As a result, reliability on the optimum power determined by performing the OPC is deteriorated, and also, reproducing of recorded data may not be well performed.

### SUMMARY OF THE INVENTION

Additional aspects and/or advantages of the invention will be set forth in part in the description which follows and, in part, will be apparent from the description, or may be learned by practice of the invention.

An aspect of the present invention is to solve at least the above problems and/or disadvantages and to provide at least the advantages described below. Accordingly, an aspect of the present invention is to provide a method for perfectly erasing a power calibration area (PCA) by performing the erasing process at least twice to improve reliability of optimum power determined through optimum power control (OPC).

In order to achieve the above-described aspects of the present invention, there is provided a method of erasing a power calibration area (PCA) for determining optimum power, including applying a command for recording data, detecting a non-recorded PCA area for performing optimum power control (OPC), and when all the PCA area is used and no non-recorded PCA area is detected, performing erasing of the PCA area at least twice.

The method may further include when any non-recorded PCA area is detected, determining optimum recording power by performing the OPC and recording signals according to the optimum recording power.

The erasing of the PCA area takes approximately 5 seconds.

The erasing of the PCA area is performed by a preset erase power while a pickup moves from a start address to a last address of the PCA area.

### BRIEF DESCRIPTION OF THE DRAWINGS

The above aspect and other features of the present invention will become more apparent by describing in detail exemplary embodiments thereof with reference to the attached drawing figures, of which;

FIG. 1 is a block diagram illustrating the structure of an optical recording/reproducing apparatus according to an embodiment of the present invention; and

FIG. 2 is a flowchart for explaining a method for erasing a power calibration area (PCA) in order for determination of optimum power, according to an embodiment of the present invention.

### DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

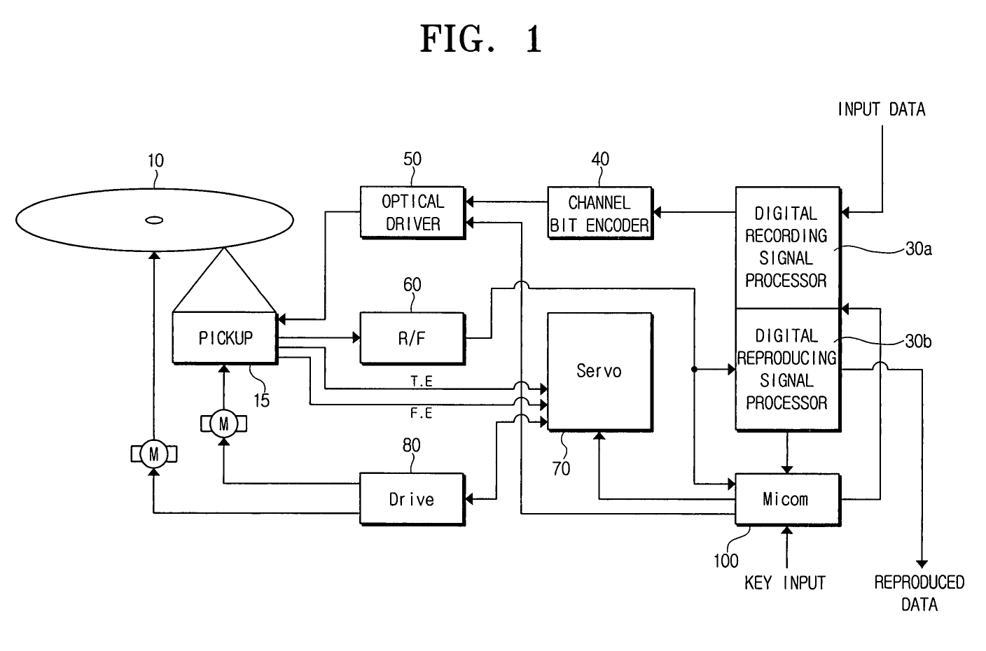

Referring to FIG. 1 illustrating the structure of an optical recording/reproducing apparatus according to an embodiment of the present invention, the optical recording/reproducing apparatus includes a digital recording signal processor 30a, a channel bit encoder 40, an optical driver 50, a pickup 15, a drive 80, a radio frequency (R/F) part 60, a servo 70, a digital reproducing signal processor 30b, and a microcomputer (micom) 100.

The digital recording signal processor 30a converts input digital data to a recording format by adding an error correction code (ECC) and outputs the converted data. The channel bit encoder 40 reconverts the converted data of the recording format into a bit stream and outputs the bit stream.

The optical driver 50 outputs a luminosity driving signal corresponding to the input signal. The pickup 15 records a signal to an optical recording medium 10 according to the luminosity driving signal output from the optical driver 50 and detects a signal from a recording surface. The drive 80 drives the pickup 15 and a motor (M).

The R/F part 60 filters and shapes the signal detected by the pickup 15 and outputs a binary signal. The servo 70 controls the operation of the drive 80 through a tracking error (TE) signal and a focusing error (FE) signal of the pickup 15 and a rotation speed of the optical recording medium 10.

The digital reproducing signal processor 30b restores the binary signal to the original data using its own clock synchronized with the binary signal supplied to the R/F part 60. The micom 100 controls the overall operation of the optical recording/reproducing apparatus.

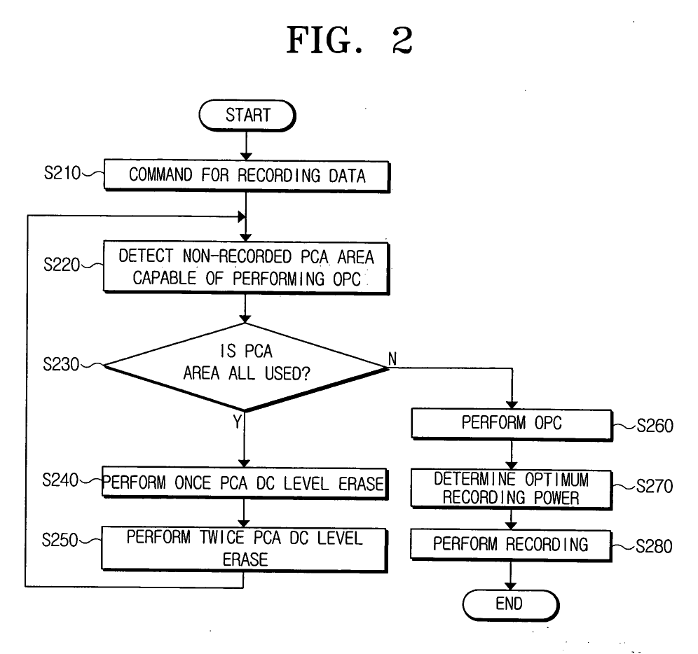

FIG. 2 is a flowchart for explaining a method of erasing a power calibration area (PCA) in order for determination of optimum power, according to an embodiment of the present invention. Referring to FIG. 2, the optical recording medium 10 is inserted to a tray (not shown). Then, the optimum recording power detection is performed upon a command for recording data externally input through the micom 100 (S210). The micom 100 detects a non-recorded PCA area which is able to perform the optimum power control (OPC) (S220).

When the non-recorded PCA area is not detected as a result of operation S220 (S230), that is, when the PCA area is filled up, the micom 100 signals to erase the PCA area (S240).

For this, the micom 100 applies a predetermined control signal for erasing the recorded area of the PCA to the servo 70. The servo 70 applies a predetermined control signal for searching a start address of the PCA area to the pickup 15, and therefore, the pickup 15 is located at the start address of the PCA area.

When the pickup 15 is located at the start address of the PCA area, the micom 100 controls the servo 70 to erase the PCA area by a preset erase power. Accordingly, the servo 70 controls the pickup 15 to move and erase from the start address to a last address of the PCA area. Here, the erase power may be a power recommended according to a manufacturer identification (ID). The erasing of the PCA area usually takes approximately 5 seconds. Generally, the PCA area is erased one time per approximately 70 times of recording.

After the PCA erasing is performed once by the pickup 15 moving up to the last address, the pickup 15 is relocated to the start address of the PCA by the control of the servo 70. The above cycle is repeated (S250). The reason of repeating the cycle at least twice in this embodiment is to prevent incomplete erasing of the PCA, which deteriorates reliability of the optimum recording power determined by performing the OPC, caused by an unstable servo or inferiority of the power setting.

After the erasing of the PCA area is performed twice, operation S220 is performed, that is, the micom 100 detects whether the non-recorded PCA area for performing the OPC is left. If all the PCA area is used and no non-recorded PCA area is detected, the erasing of the PCA area is started.

If any non-recorded area in the PCA area is detected in operation S230, the OPC process for determining the optimum recording power is performed (S260). More specifically, the micom 100 checks the counter area in the PCA of an optical disc through the pickup 15, thereby determining a location for performing the OPC, and moves the pickup 15 to a test area in the PCA.

The PCA, being set in the innermost circumference of the optical disc, includes an optical disc area and the counter area. The test area includes a hundred partition, and each partition includes sixteen sectors. One partition is used for one OPC process. The sixteen sectors of one partition are recorded with test signals of sixteen levels of laser power, respectively.

The micom 100 reads absolute time in pregroove (ATIP) information recorded on the optical recording medium 10 and records a test signal in the test area of the PCA by dividing a laser recording power into sixteen levels based on a power reference recommended by the disc manufacturer.

The micom 100 controls the pickup 15 to read, in regular sequence, the test data repeatedly recorded in the PCA and performs sampling with respect to an RF signal as sequentially read and filtered by the R/F part 60, thereby checking the luminosity of a maximum level and a minimum level.

Modulation amplitude is calculated using [Equation 1]:

$$m = \frac{\vert Top \vert - \vert Bottom \vert}{\vert Top \vert} \qquad [ Equation 1 ]$$

where ‘m’ denotes the modulation amplitude, |Top| denotes the maximum luminosity of the sampled RF signal and |Bottom| denotes the minimum luminosity of the sampled RF signal.

A polynomial expression with respect to a modulation amplitude curve (m=f(p)) is estimated through a curve fitting from the modulation amplitude at the respective recording optical powers calculated by [Equation 1].

The gamma curve refers to a regular slope of a function ‘m’ and is expressed by [Equation 2] as follows:

$$γ = \frac{ⅆ m}{ⅆ Pw} \frac{Pw}{m} \qquad [ Equation 2 )$$

Referring to [Equation 2], γ denotes a modulation change and a recording power change, and Pw denotes a recording power recorded in the test area.

The optimum recording power (Pₒ) is determined using [Equation 3] by multiplying a recording power (P_{target}) corresponding to a gamma target (γ_{target}) already determined in the gamma curve by a multiplication factor ρ (S270):
Pₒ=ρ×P_{target} [Equation 3]

The gamma target (γ_{target}) and the multiplication factor (ρ), as well as the reference power, are predetermined when manufacturing the disc and encoded in the ATIP information in the lead-in area. The gamma target (γ_{target}) and the multiplication factor (ρ) may vary according to the type of disc and the manufacturer thereof.

The optimum recording power calculated by [Equation 3] is set as the recording power to be used when recording the signal (S280). That is, the micom 100 controls the optical driver 50 so that the recording signal with respect to the input data can be output by the optimum optical driving power detected through the above processes. The optical driver 50 applies the signal by the optimum optical driving power to the pickup 15, so that the signal modulated in pulse width can be recorded in the PMA of the optical recording medium 10.

Also, when recording the data, the micom 100 determines the type of the recording signal, that is, a level and a width of the pulse based on the recording method recorded in the optical recording medium 10. The recording method is determined as a default value fixed in manufacturing. In case of the WORM optical recording medium, a log value is fixed according to a type of the recording medium while in case of RW optical recording medium, a log value is fixed according to a recording speed of the recording medium. Therefore, the data can be converted to the recording signal, that is, to the recording pulse using the optimum recording power calculated with reference to the type of the recording signal, and recorded to the optical recording medium 10.

As can be appreciated from the above, according to an embodiment of the present invention, reliability of the optimum recording power determined by the OPC can be improved by completely erasing the PCA area at least twice.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method for erasing a power calibration area (PCA), comprising:
applying a command for recording data;
detecting a non-recorded PCA area for performing optimum power control (OPC); and
when all the PCA area is used and no non-recorded PCA area is detected, performing erasing of the PCA area at least twice.

2. The method of claim 1, further comprising when any non-recorded PCA area is detected, determining optimum recording power by performing the OPC and recording signals using the optimum recording power.

3. The method of claim 1, wherein the erasing of the PCA area takes approximately 5 seconds.

4. The method of claim 1, wherein the erasing of the PCA area is performed by a preset erase power while a pickup moves from a start address to a last address of the PCA area.

5. The method of claim 1, wherein the PCA area is erased one time per approximately 70 times of recording.

6. An optical recording/reproducing apparatus, comprising:
a digital recording signal processor;
a channel bit encoder;
an optical driver;
a pickup;
a drive;
a radio frequency (R/F) part;
a servo;
a digital reproducing signal processor; and
a microcomputer.

7. The apparatus of claim 6, wherein the digital recording signal processor converts input digital data to a recording format by adding an error correction code and outputs the converted data to the channel bit encoder.

8. The apparatus of claim 7, wherein the channel bit encoder reconverts the converted data of the recording format into a bit stream and outputs the bit stream to the optical driver.

9. The apparatus of claim 8, wherein the optical driver outputs a luminosity driving signal corresponding to the input signal to the optical pickup.

10. The apparatus of claim 9, wherein the pickup records a signal to an optical recording medium according to the luminosity driving signal output from the optical driver and detects a signal from a recording surface.

11. The apparatus of claim 10, wherein the drive drives the pickup and a motor.

12. The apparatus of claim 11, wherein the R/F part filters and shapes the signal detected by the pickup and outputs a binary signal.

13. The apparatus of claim 12, wherein the servo controls the operation of the drive through a tracking error signal and a focusing error signal of the pickup and a rotation speed of the optical recording medium.

14. The apparatus of claim 13, wherein the digital reproducing signal processor restores the binary signal to the original data using it's own clock synchronized with the binary signal supplied to the R/F part.

15. The apparatus of claim 14, wherein the microcomputer controls the overall operation of the optical recording/reproducing apparatus.

16. A method for erasing a power calibration area (PCA) of an optical recording medium using an optical recording/reproducing apparatus, the optical recording reproducing apparatus comprising a pickup, a microcomputer and a servo, the method comprising:
applying a command for recording data;
detecting a non-recorded PCA area for performing optimum power control (OPC); and
when all the PCA area is used and no non-recorded PCA area is detected, performing erasing of the PCA area at least twice using the pickup.

17. The method of claim 16, further comprising when any non-recorded PCA area is detected, determining optimum recording power by performing the OPC and recording signals using the optimum recording power.

18. The method of claim 16, further comprising reading absolute time in pregroove information recorded on the optical recording medium using the microcomputer and recording a test signal in the test area of the PCA by dividing a laser recording power into sixteen levels based on a predetermined power reference.

19. The method of claim 18, wherein the microcomputer controls the pickup to read the test data repeatedly recorded in the PCA and performs sampling with respect to a radio frequency signal as sequentially read and filtered by a radio frequency part to check the luminosity of a maximum level and a minimum level.
